(19) United States
(12) Patent Application Publication
(10) Pub. No.: US 2010/0008885 A1
(43) Pub. Date: Jan. 14, 2010

(54) METHODS AND KITS IMPARTING BENEFITS TO KERATIN-CONTAINING SUBSTRATES

(76) Inventors: Susan Daly, Basking Ridge, NJ (US); Janusz Jachowicz, Bethel, NJ (US); Robert Bianchini, Hillsborough, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/169,984

(22) Filed: Jul. 9, 2008

(51) Int. Cl. A61Q 5/12

(52) U.S. Cl. 424/70.27

(57) ABSTRACT

This invention relates to methods for providing cosmetic or other benefits to keratin-containing substrates by sequential treatment with cationically and anionically charged compounds, and compositions and kits containing them.

### FIELD OF THE INVENTION

This invention relates to methods of imparting benefits, including, but not limited to, conditioning, to keratin-containing substrates, and more particularly to methods and kits for imparting benefits to hair by the sequential application of cationically and anionically charged compounds.

### BACKGROUND OF THE INVENTION

Consumers desire conditioned hair with such attributes as shine, manageability, and ease of combing. There are many ways of providing these attributes, usually involving the application of compositions to smooth, coat, or otherwise alter the surface of the hair. Such compositions include polymers such as film-forming, conditioning polymers

Hair is generally negatively charged when in the presence of compositions having a pH above 1-4, a working range for typical non-reactive hair care products such as shampoos and conditioners. Hair is generally positively charged at pH values below 1-4. The isoelectric point of hair, i.e., the pH at which a keratin surface carries no net electrical charge, is, therefore, generally in the pH range of approximately 1 to 4. Consequently, cationic compounds have been used as conditioning agents in order to improve the wet and dry ease of combing of hair. The application of cationic quaternary ammonium compounds onto negatively charged hair facilitates detangling during wet hair combing and a reduction in static flyaway during dry hair combing. Cationic quaternary ammonium compounds generally also impart softness and suppleness to hair. However, other cationic compounds, such as cationic peptides and proteins, may decrease ease of combing of the hair. Thus, as consumer hair care products are engineered to provide additional benefits to the hair, some of the agents that provide these benefits, such as proteins or peptides or coloring agents, may decrease the look, feel, and ease of combing of the hair.

Another method that has been used to condition the hair involves mixing anionically charged materials with cationic materials in solution to form a complex. The solution is applied to the hair and the complex “crashes” out of the solution onto the hair. This approach may produce unacceptable hair attributes, such as decreased look, feel and ease of combing, due to the large aggregates of the complex that are deposited on the hair surface.

In view of the limited choices for known conditioning methods, new methods of conditioning the hair and other keratin-containing surfaces are needed.

### SUMMARY OF THE INVENTION

This invention relates to a method of providing a benefit to a keratin-containing substrate. The method comprises the following sequential steps:
a) providing a first cosmetic composition comprising at least one cationic compound selected from the group consisting of cationic proteins, cationic peptides, cationic polymers, and the mixtures thereof;
b) applying said first cosmetic composition to the keratin-containing substrate for a time period sufficient for at least one said cationic compound to be deposited on the substrate and form a first layer;
c) providing a second cosmetic composition comprising at least one anionic compound selected from the group consisting of anionic proteins, anionic peptides, anionic polymers, anionic surfactants, and the mixtures thereof; and
   applying said second cosmetic composition to the keratin-containing substrate for a time period sufficient for at least one anionic compound to be deposited on said first layer to form a second layer.

More particularly, the methods of this invention relate to the following sequential steps:
a) providing a first cosmetic composition containing at least one cationic compound selected from the group consisting of cationic proteins, cationic peptides, cationic polymers, and mixtures of these;
b) applying the first cosmetic composition to the keratin-containing substrate for a time period sufficient for at least one cationic compound to be deposited on the substrate and form a first layer;
c) the first cosmetic composition may then be rinsed from the substrate with water or other aqueous solutions, such as buffer solutions, salt solutions, and lower alcohol (C2-C6) solutions with an alcohol content of between about 0.1% to about 20% by weight, or may be left on the substrate to provide conditioning benefits as a leave-on product;
d) providing a second cosmetic composition containing at least one anionic conditioning compound selected from the group consisting of anionic proteins, anionic peptides, anionic polymers, anionic surfactants, and mixtures of these;
e) applying the second cosmetic composition to the keratin-containing substrate for a time period sufficient for at least one anionic compound to be deposited on said first layer to form a second layer; and
f) optionally rinsing the second cosmetic composition with water or other aqueous solutions, such as buffer solutions, salt solutions, and lower alcohol (c2-C6) solutions with an alcohol content of between about 0.1% to about 20% by weight.

This invention also relates to a kit for imparting a benefit to a keratin-containing substrate. The kit has:
a) a first container containing a first cosmetic composition having at least one cationic compound selected from the group consisting of cationic proteins, cationic peptides, cationic polymer, and mixtures of these;
   wherein the first composition is applied to the keratin-containing substrate for a time period sufficient for at least one cationic compound to be deposited on the substrate and form a first layer, and then may be optionally rinsed off with water; and
b) a second container containing a second cosmetic composition having at least one anionic agent selected from the group consisting of anionic proteins, anionic peptides, anionic polymers, and mixtures of these;
   wherein the second cosmetic composition is applied to the keratin-containing substrate for a time period sufficient for at least one anionic compound to be deposited on the first layer to form a second layer, and then may be optionally rinsed off with water.

Other features and advantages of this invention will be apparent from the detailed description of the invention and from the claims.

### BRIEF DESCRIPTION OF THE DRAWINGS

FIG. 1 is a chart of streaming potential analysis, illustrating the results obtained in Example 1.

### DETAILED DESCRIPTION OF THE INVENTION

The method of this invention unexpectedly provides an improvement in the ease of combing after hair is first treated with a cationic compound and then subsequently treated with an anionic compound.

Cationic compounds are often selected as hair conditioners because of their affinity for the negatively charged surface of hair. However, the treatment of hair with cationic compounds can form a layer on the hair that either increases or decreases the ease of combing. Certain cationic proteins and peptides, while providing strengthening, mending, and thickening benefits to the hair, may also cause it to become stiffer, more easily tangled, and more difficult to comb, which are unacceptable attributes to the consumer. Other cationic compounds, such as cationic quaternary ammonium compounds, improve the shine, softness, and ease of combing of the hair.

The method of this invention provides a multi-step treatment that surprisingly and unexpectedly results in improved ease of combing when the hair is treated first with a cationic compound and subsequently with an anionic compound, regardless of whether the first cationic compound alone increases or decreases the ease of combing. Surprisingly, increased ease of combing is provided even when the anionic compound of the subsequent treatment is sodium laureth sulfate (SLES), a common surfactant used in shampoos. Shampoos alone typically do not improve the ease of combing. In fact, SLES, an anionic compound that may be used in the second cosmetic composition of this invention, provides no benefit to hair when used alone, i.e., without the multi-step treatment described herein.

In addition to conditioning benefits, the compositions and kits of this invention may be utilized to impart any other benefits to keratin-containing substrates that may be available in the form of active anionic agents. Such benefits can include conditioning as well as biological benefits.

It is believed that one skilled in the art can, based upon the description herein, utilize the compositions and methods of this invention to their fullest extent. The following specific embodiments are to be construed as merely illustrative, and not limitative of the remainder of the disclosure in any way whatsoever.

Unless defined otherwise, all technical and scientific terms used herein have the same meaning as commonly understood by one of ordinary skill in the art to which the invention belongs. Also, all publications, patent applications, patents, and other references mentioned herein are incorporated by reference. Unless otherwise indicated, a percentage refers to a percentage by weight (i.e., % (W/W)).

### DEFINITIONS

“Keratin-containing substrate”, as used herein, includes hair, skin, nails, teeth, tissues, wool, fur, and any other materials that contain keratin proteins. The keratin-containing substrate of this invention is preferably human hair, skin, or nail.

“Cationic compound”, as used herein, relates to a compound with a positive charge. Such compounds generally move toward the negative electrode in electrolysis.

“Anionic compound”, as used herein, relates to a compound with a negative charge. Such compounds generally move toward the positive electrode in electrolysis.

“Naturally-occurring”, as used herein, relates to compounds that occur in nature without human intervention. It may also relate to compounds that are synthesized by humans to be identical to those that occur in nature.

“Peptide”, as used herein, is a molecule containing two or more amino acids joined by a peptide bond or modified peptide bonds.

The term “amino acid” refers to the basic chemical structural unit of a protein or polypeptide. The following abbreviations are used herein to identify specific amino acids:

TABLE 1

| | Three-Letter | One-Letter |
|---|---|---|
| Amino Acid | Abbreviation | Abbreviation |
| Alanine | Ala | A |
| Arginine | Arg | R |
| Asparagine | Asn | N |
| Aspartic acid | Asp | D |
| Cysteine | Cys | C |
| Glutamine | Gln | Q |
| Glutamic acid | Glu | E |
| Glycine | Gly | G |
| Histidine | His | H |
| Isoleucine | Ile | I |
| Leucine | Leu | L |
| Lysine | Lys | K |
| Methionine | Met | M |
| Phenylalanine | Phe | F |
| Proline | Pro | P |
| Serine | Ser | S |
| Threonine | Thr | T |
| Tryptophan | Trp | W |
| Tyrosine | Tyr | Y |
| Valine | Val | V |

“Protein”, as used herein, relates to a long chain of amino acids joined together by peptide bonds. Proteins may generally have molecular weights more than 10,000.

“Polymer”, as used herein, relates to a large organic molecule formed by combining many smaller molecules (monomers) in a regular pattern.

### Cationic Compounds

The cationic compounds useful in the compositions and methods of this invention include cationic proteins, cationic peptides, cationic polymers, and mixtures of these.

Cationic proteins include naturally-occurring cationic proteins and synthetic cationic proteins. Examples of naturally-occurring cationic proteins include lysozyme; avidin; methylated collagen; Cytochrome C; Platelet Factor 4; Protamine sulfate; Telomerase; cationic proteases, including trypsin, chymotrypsin, papain, caspase; RNA or DNA binding proteins, including histones, Ribonuclease A, Deoxyribonuclease; and antimicrobial proteins, including magainin, defensins, and cathelicdin. Examples of cationic synthetic peptides or proteins include polylysine, polyarginine, polyhistidine, and copolymers, peptides and proteins containing a greater total number of basic amino acids, such as lysine, arginine, and histidine, than acidic amino acids, such as aspartic acid and glutamic acid. These copolymers, peptides, and proteins will have a net charge of at least 1+ at a neutral pH (pH=6.0-7.5). Examples include, poly (Lys, Tyr) hydrobromide, and poly (Arg, Trp) hydrobromide all available from Sigma Aldrich.

Cationic polymers include naturally-occurring polymers that are cationically modified and synthetic cationic polymers. Examples of naturally-occurring polymers that are cationically modified include, without limitation, chitosan, cationic guar gum, cationic starch, and cationic cellulose. Examples of cationic cellulose include but are not limited to polyquaternium-4, polyquaternium-10, polyquaternium-24, and modifications of these.

Examples of synthetic cationic polymers include, without limitation, synthetic cationic polymers with one or more primary amines, synthetic cationic polymers with one or more secondary amines, synthetic cationic polymers with one or more tertiary amines, synthetic cationic polymers with one or more quaternary amines, and mixtures of these. Specific examples of synthetic cationic polymers include, without limitation, homopolymers or copolymers derived from acrylic or methacrylic esters or amides, such as poly methacrylamidopropyltrimethylammonium chloride, polyquaternium-1, polyquaternium-2, polyquaternium-5, polyquaternium-6, polyquaternium-7, polyquaternium-8, polyquaternium-11, polyquaternium-16, polyquaternium-17, polyquaternium-18, polyquaternium-22, polyquaternium-27, polyquaternium-28, polyquaternium 31, polyquaternium-39, polyquaternium-43, polyquaternium-44, polyquaternium-46, polyquarternium-47, polyquaternium-53, polyquaternium-55, PVP/dimethylaminoethyl methacrylate copolymer, VP/dimethylaminoethyl methacrylate copolymer, VP/DMAPA acrylate copolymer, VP/vinyl caprolactam/DMAPA acrylates copolymer, vinylcaprolactam/PVP/dimethylaminoethylmethacrylate copolymer, and mixtures of these.

The cationic compounds of this invention preferably have an Isoelectric Point of greater than 6, preferably about 8 to about 12.

The cationic compounds used in this invention have a concentration in the first cosmetic composition ranging from about 0.000001% to about 10% by weight, more preferably from about 0.001% to about 5% by weight, and even more preferably from about 0.01% to about 2% by weight.

### Anionic Compounds

The anionic compounds useful in the compositions and methods of this invention include anionic proteins, anionic peptides, anionic polymers, anionic surfactants, and mixtures of these. Anionic proteins include naturally-occurring anionic proteins and synthetic anionic proteins. Examples of naturally-occurring anionic proteins include, without limitation, wheat acidic esterase; alkaline phosphatase; beta-galactosidase; lactase; lipase; amylases; Epidermal Growth Factor; glycosidases; glucose oxidase; nitrate reductase; catalase; lactoglobulin; carboanhydrase; casein proteins from milk; trypsin inhibitor; albumin; anionic proteases, such as cathepsin; proteins from egg white, including ovalbumin, gamma-globulin, and ovomucin.

Synthetic anionic proteins include, for example, polyglutamic acid, polyaspartic acid, and copolymers and proteins containing a greater number of acidic amino acids than basic amino acids. In other words, such copolymers and proteins contain sufficient glutamic acid or aspartic acid amino acids such that the net charge is negative.

Examples of anionic peptides include, without limitation, polyglutamic acid, polyaspartic acid, and copolymers and peptides containing a greater number of acidic amino acids than basic amino acids. In other words, such copolymers and proteins contain sufficient glutamic acid or aspartic acid amino acids such that the net charge is negative. Examples include poly (Glu, Ala, Tyr) sodium salt and poly (Glu, Tyr) sodium salt available from Sigma Aldrich.

Anionic polymers include naturally-occurring anionic polymers and synthetic anionic polymers. Examples of naturally-occurring anionic polymers include, without limitation, alginic acid, propylene glycol alginate, carrageenan gum, gum acacia, karaya gum, xanthan gum, tragacanth gum, hyaluronic acid, shellac, anionically modified cellulose, guar gum, starch and mixtures of these.

Nonlimiting examples of synthetic anionic polymers include sodium polystyrene sulfonate, sodium polymethacrylate, sodium polynapthalenesulphonate, acrylates/C10-30 alkyl acrylate crosspolymer, acrylates/beheneth-25 methacrylate copolymer, acrylates/steareth-20 methacrylate copolymer, acrylates/VA crosspolymer, acrylic acid/acrylonitrogens copolymer, carbomerPVM/MA decadiene crosspolymer, acrylates copolymer, octylacrylamide/acrylates/butylaminoethylmethacrylate copolymer, PVM/MA copolymer, VA/crotonates/vinyl neodecanoate copolymer, glyceryl polymethacrylate, and mixtures of these.

Anionic surfactants include alkyl sulphates, alkyl ether sulphates, alkaryl sulphonates, alkanoyl isethionates, alkyl succinates, alkyl sulphosuccinates, N-alkyl sarcosinates, alkyl phosphates, alkyl ether phosphates, alkyl ether carboxylates, and alpha-olefin sulphonates, especially their sodium, magnesium, ammonium, and mono-, di-, and triethanolamine salts. The alkyl and acyl groups generally contain from 8 to 18 carbon atoms and may be unsaturated. The alkyl ether sulfates, alkyl ether phosphates, and alkyl ether carboxylates may contain from 1 to 10 ethylene oxide or propylene oxide units per molecule.

Nonlimiting examples of synthetic anionic surfactants include sodium laureth sulfate (SLES), ammonium lauryl ether sulfate (ALES)(n)EO, (where n ranges from 1 to 3), sodium trideceth sulfate, ammonium lauryl sulfosuccinate, sodium dodecylbenzene sulfonate, sodium cocoyl isethionate, N-lauryl sarcosinate, laureth-1 phosphate, linear alcohol ethoxy phosphate, and mixtures of these.

The anionic compounds useful in the compositions and methods of this invention have an Isoelectric Point of about 7 to about 2.

The anionic compounds in this invention have a concentration in the second cosmetic composition ranging from about 0.000001% to about 10% by weight, more preferably from about 0.001% to about 5% by weight, and even more preferably from about 0.01% to about 2% by weight.

### Streaming Potential

Streaming potential is an electrokinetic measurement determined by passing an electrolytic solution through a permeable body, such as a capillary, a porous solid, or a plug of fiber such as hair. The streaming of the liquid through the permeable body produces an electrokinetic potential that may be measured. An electrometer may be used to measure the electrical potential across the plug caused by the flow of liquid. A detailed description of streaming potential can be found in U.S. Pat. No. 5,452,233.

In the present invention, streaming potential analysis is used to measure the surface charge on hair before and after treatments with certain compounds. Any change in streaming potential after treatment indicates a change in the surface charge of the hair, and thus the streaming potential measurement may be used to monitor the deposition and retention of the treatment compounds on the hair. The measurement is illustrated as a graph where the x-axis represents time, measured in seconds in this invention, and the y-axis represents the streaming potential, measured in millivolts (mV) in this invention.

### Zeta Potential

Zeta potential is the average potential in the hydrodynamic plane of shear, separating the bulk liquid phase and the diffuse layers of the electrochemical double layer, and can be calculated from the streaming potential or streaming current measurement.

### Combing Analysis

An indicator of conditioning of hair is ease of combing, which is directly related to hair manageability, protection, and damage. Ease of combing may be measured by determining the work required to drag a comb through a sample of hair (also referred to as “combing force”). This work is measured using a Dia-Stron combing apparatus available from Dia-Stron Corporation, Hampshire, UK. Preferably, this work is less than about 0.2 joules for healthy and conditioned hair.

The human hair used in the examples below was blonde hair. Such hair is available commercially, for example from International Hair Importers and Products (Bellerose, N.Y.), and is also available in different colors, such as brown, black, red, and blonde, and in various types, such as African-American, Caucasian, and Asian.

### Other Cosmetic Components and Additives

In addition to the above-described ingredients, other common cosmetic components and additives known or otherwise effective for use in hair care or personal care products may be incorporated in the compositions of this invention, as long as the basic properties of the compositions, and the ability to condition substrates, are not adversely affected. Such optional ingredients include, but are not limited to, anti-dandruff agents, hair growth agents, anti-inflammatory agents, anti-microbial agents, anionic and nonionic surfactants, suspending agents, humectants, emollients, moisturizers, fragrances, dyes and colorants, foam stabilizers, anti-static agents, preservatives, rheology modifiers, water softening agents, chelants, hydrotropes, polyalkylene glycols, acids, bases, buffers, beads, pearlescent aids, fatty alcohols, proteins, skin active agents, sunscreens, vitamins, thickeners, and pediculocides, and the like. Optional components may be present in weight percentages of less than about 1% each, and from about 0.01% to about 10% by weight of the composition in total.

### Cosmetically Acceptable Carriers

The compositions of this invention preferably contain one or more cosmetically-acceptable carriers. Preferably, such carriers include water. Organic solvents may also be included in order to facilitate manufacturing of the compositions or to provide esthetic properties, such as viscosity control. Suitable solvents include the lower alcohols, or C2-C6 alcohols, such as ethanol, propanol, isopropanol, butanols, pentanols, and hexanols; glycol ethers, such as 2-butoxyethanol, ethylene glycol monoethyl ether, propylene glycol and diethylene glycol monoethyl ether or monomethyl ether; and the mixtures thereof. A preferred organic solvent in this invention is ethanol. Non-aqueous solvents may be present in the compositions of this invention in an amount of about 0.01% to about 50%, and in particular about 0.1% to about 20%, by weight of the total weight of the carrier in the compositions.

The compositions of this invention should be stable to phase or ingredient separation at a temperature of about 25° C. for a long period of time, or at least for about 26 weeks at a temperature of between 4° C. and 40° C. Thus, the compositions of this invention have demonstrated sufficient stability to phase and ingredient separation at temperatures normally found in commercial product storage and shipping to remain unaffected for a period of at least six months.

This invention also relates to methods of using the compositions of this invention to condition keratin-containing substrates, including hair. Although the following recites hair as the substrate to be conditioned, the method described herein may be applied to other keratin-containing substrates that are amenable to conditioning with cationically and anionically charged compounds such as are described in this invention. Treatment of hair with the compositions of this invention is generally carried out by: (1) applying to wet or dry hair a sufficient amount of a conditioning composition according to the invention; (2) distributing a composition according to this invention more or less evenly throughout the hair such that it contacts all the hair or other substrates which is intended to be conditioned. This permits the cationically and anionically charged compounds of the compositions of this invention to deposit onto the surface of the hair or other keratin-containing substrate. This distribution step may be accomplished by rubbing the composition throughout the hair manually or using a hair appliance such as a comb or a brush for up to about 30 seconds to about 30 minutes; and (3) rinsing said hair or other substrates so as to remove excess material that has not adsorbed onto the hair. The hair may be rinsed with water, buffer solutions, salt solutions, and lower alcohol (C2-C4 alcohols) solutions with an alcohol content of from about 0.1% to about 20% by weight. Treatment of hair with the compositions of the invention may also be carried out by applying leave-on types of compositions of this invention, such as sprays, creams, foams, or solutions, directly to hair without rinsing the hair.

### EXAMPLE 1

Streaming potential analysis was conducted on blonde hair showing the effect on streaming potential of a first treatment with a solution of cationic polyquaternium-6 (available as Merquat 100 from Nalco Company in Naperville, Ill.) and a second treatment with a solution of anionic protein chicken albumin (available from Sigma Aldrich, St. Louis, Mo.). The solutions of 0.0125% cationic polyquaternium-6 and 0.0125% anionic protein chicken albumin were prepared and utilized at the concentrations noted above in 1 mM KCl in deionized water.

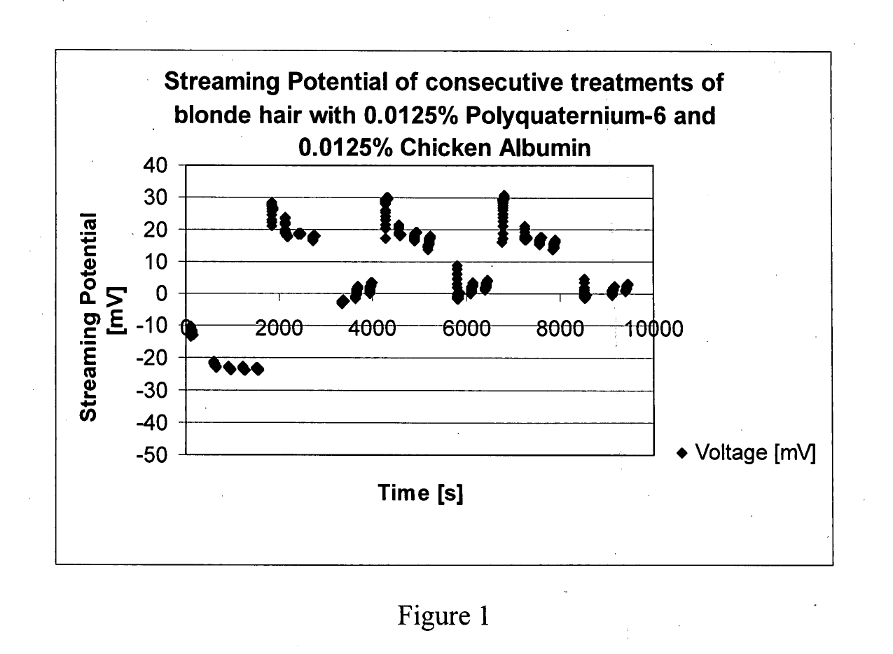

Referring now to FIG. 1, the first five data points_correspond to untreated hair, the next four data points correspond to hair after treatment with the cationic polyquaternium-6, and the next three data points correspond to hair after treatment with the anionic chicken albumin. The cycle of treatments was continued two more times. The increase in surface charge after the cationic polyquaternium-6 treatment shows that the polyquaternium-6 is deposited and retained on the hair to form a first layer. The decrease in surface charge after the subsequent treatment with anionic peptide chicken albumin indicates that the albumin is deposited on the first layer to form a second layer. The changes in surface charge corresponding to the subsequent treatments demonstrate that additional layers are being deposited and retained on the previously deposited layers.

### EXAMPLE 2

Combing analysis of blonde hair treated by consecutive multilayer deposition of this invention was conducted. All solutions used for the treatments consisted of 1% of the active composition in deionized water.

Combing analysis was conducted on the untreated hair, on the hair after a first treatment with 1% polylysine, on the hair after a second treatment with 1% albumin, and finally on the hair after a third treatment with 1% SLES. Table 2 shows the results of the combing analysis.

TABLE 2

| | | Combing force | |
|---|---|---|---|
| Treatment | Source of Active | (Joules) | Std. dev. |
| Untreated | N/A | 2.51E−01 | 0.028921 |
| 1% polylysine | Sigma Aldrich (P6516) | 1.85E−01 | 0.020789 |
| 1% chicken albumin | Sigma Aldrich | 1.36E−01 | 0.020435 |
| 1% SLES | Rhodia, Cranbury, NJ | 1.20E−01 | 0.060033 |
| | (Rhodapex ES-2K) | | |

Referring now to Table 2, it can be seen that the work required to comb the hair decreased after the treatment with the polylysine. Surprisingly, the combing force was reduced even further after treatment with albumin and after exposure to SLES, which can form complexes with the underlying layers. The treatment with SLES did not decrease the ease of combing, indicating that the polylysine and the albumin treatments were depositing on the hair to create first and second layers, respectively, and remaining even with exposure to SLES.

### EXAMPLE 3

Combing analysis was conducted on blonde hair in a manner similar to that of Example 2 above, except that 1% polyquaternium-6, 1% albumin, and 1% SLES were used as the treatment compositions. The results are shown in Table 3.

TABLE 3

| | | Combing force | |
|---|---|---|---|
| Treatment | Source of Active | (Joules) | Std. dev. |
| Untreated | N/A | 1.47E−01 | 0.004313 |
| 1% | Nalco Company | 1.31E−01 | 0.009899 |
| polyquaternium-6 | (Merquat 100) | | |
| 1% chicken albumin | Sigma Aldrich | 1.09E−01 | 0.054956 |
| 1% SLES | Rhodia (Rhodapex ES- | 9.89E−02 | 0.010232 |
| | 2K) | | |

Referring now to Table 3, it can be seen that the work required to comb the hair decreased after the first treatment with the 1% polyquaternium-6, then decreased further after the second treatment with the anionic albumin, and finally decreased even more after the treatment with the SLES. Again surprisingly, the combing force was reduced even further after treatment with albumin and after exposure to SLES, which can form complexes with the underlying layers. The treatment with SLES did not decrease the ease of combing, indicating that the polyquaternium-6 and the albumin treatments were depositing on the hair to create first and second layers, respectively, and remaining even with exposure to SLES.

### EXAMPLE 4

Combing analysis was conducted on blonde hair in a manner similar to that of Example 2 above, except that 1% lysozyme, 1% albumin, and 1% SLES were used as the treatment compositions. The results are shown in Table 4.

TABLE 4

| | | Combing force | |
|---|---|---|---|
| Treatment | Source of Active | (Joules) | Std. dev. |
| Untreated | N/A | 1.95E−01 | 0.060316 |
| 1% lysozyme | Sigma Aldrich | 5.28E−01 | 0.055508 |
| 1% chicken | Sigma Aldrich | 4.28E−01 | 0.05717 |
| albumin | | | |
| 1% SLES | Rhodia (Rhodapex ES- | 2.80E−01 | 5.39E−02 |
| | 2K) | | |

Referring now to Table 4, it can be seen that, although the first treatment with the cationic protein lysozyme increased the work required to comb the hair, the subsequent treatments with anionic albumin and SLES decreased the combing force.

### EXAMPLE 5

Combing analysis was conducted on blonde hair in a manner similar to that of Example 2 above, except that the hair was dyed before subsequent treatments with 1% lysozyme, 1% albumin, and 1% SLES. The results are shown in Table 5.

TABLE 5

| | | Combing force | |
|---|---|---|---|
| Treatment | Source of Active | (Joules) | Std. dev. |
| Untreated | N/A | 1.57E−01 | 0.054039 |
| Dyed hair | N/A | 2.32E−01 | 0.073668 |
| 1% lysozyme | Sigma Aldrich | 4.93E−01 | 0.096313 |
| 1% chicken | Sigma Aldrich | 5.26E−01 | 0.224137 |
| albumin | | | |
| 1% SLES | Rhodia (Rhodapex ES- | 2.23E−01 | 0.136328 |
| | 2K) | | |

Referring now to Table 5, it can be seen that the dying of the hair increased the combing force, as did the first treatment with the cationic protein lysozyme and the subsequent treatment with anionic albumin. SLES decreased the combing force. This is a pattern of behavior similar to that observed for untreated hair described in Example 4.

### EXAMPLE 6

Combing analysis was conducted on blonde hair in a manner similar to that of Example 2 above, except that 0.5% Avidin, 1% albumin, and 1% SLES were used as the treatment compositions. The results are shown in Table 6.

TABLE 6

| | | Combing force | |
|---|---|---|---|
| Treatment | Source of Active | (Joules) | Std. dev. |
| Untreated | N/A | 2.76E−01 | 0.00297 |
| 0.5% Avidin | Sigma Aldrich | 4.20E−01 | 0.06371 |
| 1% chicken | Sigma Aldrich | 3.55E−01 | 0.03684 |
| albumin | | | |
| 1% SLES | Rhodia (Rhodapex ES- | 3.16E−01 | 0.001061 |
| | 2K) | | |

Referring now to Table 6, it can be seen that, although the first treatment with the cationic protein avidin increased the work required to comb the hair, the subsequent treatments with anionic albumin and SLES decreased the combing force.

The examples and data above demonstrate that a variety of frictional effects can be achieved by the subsequent treatments of hair with a first cationic compound and a second anionic compound to form multiple layers on the hair. These effects are then retained after rinsing, an in some cases, improved by treatment with SLES.

### EXAMPLE 7

### Skin Tightening Gel

A skin tightening gel for use according to the present invention is made as described.

TABLE 7A

| Ingredient | Wt. % | Source of materials |
|---|---|---|
| Phase A | | |
| Deionized water | 92.3 | N/A |
| Carbomer 934 | 0.40 | Noveon Consumer |
| | | Specialties Lubrizol |
| | | Advanced Materials, |
| | | Inc., Cleveland OH |
| Butylene glycol | 1.0 | Sigma Aldrich, St. |
| | | Louis, MO |
| Propylene glycol | 1.0 | Sigma Aldrich, St. |
| | | Louis, MO |
| Glycerine | 0.5 | Sigma Aldrich, St. |
| | | Louis, MO |
| Cellulose gum | 1.0 | Hercules Incorporated |
| | | Aqualon Division, |
| | | Wilmington DE |
| Avidin (100%) | 1.0 | Sigma Aldrich, St. |
| | | Louis, MO |
| Phase B | | |
| GERMABEN II (Propylene | 0.5 | Sutton Laboratories |
| Glycol, Diazolidinyl | | Member of the ISP |
| Urea, Methyl Paraben, | | Group, |
| Propylparaben | | Chatham NJ |
| Phase C | | |
| Triethanolamine | 1.0 | Sigma Aldrich, St. |
| | | Louis, MO |
| Phase D | | |
| Fragrance | 0.30 | Firmenich Inc., |
| | | Princeton NJ |

Referring to Table 7A, the components of Phase A are mixed together until homogeneous. Phases B, C, and D are added to Phase A and mixed until homogeneous and clear to make the skin tightening gel first composition.

TABLE 7B

| Ingredient | Wt. % | Source of materials |
|---|---|---|
| Phase E | | |
| Deionized water | 91.3 | N/A |
| Carbomer 943 | 0.40 | Noveon Consumer |
| | | Specialties Lubrizol |
| | | Advanced Materials, |
| | | Inc., Cleveland OH |
| Butylene glycol | 1.0 | Sigma Aldrich, St. |
| | | Louis, MO |
| Propylene glycol | 1.0 | Sigma Aldrich, St. |
| | | Louis, MO |
| Glycerine | 0.5 | Sigma Aldrich, St. |
| | | Louis, MO |
| Cellulose gum | 1.0 | Hercules Incorporated |
| | | Aqualon Division, |
| | | Wilmington DE |
| Albumin (100%) | 2.0 | Sigma Aldrich, St. |
| | | Louis, MO |
| Phase F | | |
| GERMABEN II (Propylene | 0.5 | Sutton Laboratories |
| Glycol, Diazolidinyl | | Member of the ISP |
| Urea, Methyl Paraben, | | Group, |
| Propylparaben | | Chatham NJ |
| Phase G | | |
| Triethanolamine | 1.0 | Sigma Aldrich, St. |
| | | Louis, MO |
| Phase H | | |
| Fragrance | 0.30 | Firmenich Inc., |
| | | Princeton NJ |

Referring to Table 7B, the components of Phase E are mixed together until homogeneous. Phases F, G, and H are added to Phase E and mixed until homogeneous and clear to make the skin tightening gel second composition.

The skin tightening gel first and second compositions are applied to the skin consecutively, with each application being followed by rinsing with water.

### EXAMPLE 8

### Conditioning Cream Rinse Formulation

A conditioning cream rinse formulation for use according to the present invention is made as described.

TABLE 8A

| Ingredient | Wt. % | Source of materials |
|---|---|---|
| Phase A | | |
| Deionized water | 92.3 | N/A |
| NaEDTA | 0.1 | The Dow Chemical |
| | | Company |
| | | Larkin Laboratory, |
| | | Midland MI |
| Polyquaternium-6 | 0.5 | Nalco Company, |
| | | Naperville, IL |
| Phase B | | |
| Cetearyl alcohol | 4.0 | Croda, Inc., Edison NJ |
| Gyceryl stearate | 1.5 | International |
| | | Specialty Products, |
| | | Wayne NJ |
| PEG-20 stearate | 1.5 | Uniqema, Redcar |
| | | Cleveland TS10 4RF |
| | | United Kingdom |
| Phase C | | |
| Diazolidinyl urea/IPBC | 0.1 | International |
| (Germall Plus) | | Specialty Products, |
| | | Wayne, NJ |

Referring to Table 8A, Phase A ingredients are combined and heated to 60° C. with moderately slow stirring. The components of Phase B are melted and slowly added to Phase A with stirring until the mixture appears well mixed and homogeneous. The solution is allowed to cool to ambient temperature with continued slow stirring. Phase C is added with stirring to make a conditioning cream rinse first composition.

TABLE 8B

| Ingredient | Wt. % | Source of materials |
|---|---|---|
| Phase D | | |
| Deionized water | 90.3 | N/A |
| NaEDTA | 0.1 | The Dow Chemical |
| | | Company |
| | | Larkin Laboratory, |
| | | Midland MI |
| Chicken albumin | 2.5 | Sigma Aldrich, St. |
| | | Louis, MO |
| Phase E | | |
| Cetearyl alcohol | 4.0 | Croda, Inc., Edison NJ |
| Gyceryl stearate | 1.5 | International |
| | | Specialty Products, |
| | | Wayne NJ |
| PEG-20 stearate | 1.5 | Uniqema, Redcar |
| | | Cleveland TS10 4RF |
| | | United Kingdom |
| Phase F | | |
| Diazolidinyl urea/IPBC | 0.1 | International |
| (Germall Plus) | | Specialty Products, |
| | | Wayne, NJ |

Referring to Table 8B, Phase D ingredients are combined and heated to 60° C. with moderately slow stirring. The components of Phase E are melted and slowly added to Phase D with stirring until the mixture appears well mixed and homogeneous. The solution is allowed to cool to ambient temperature with continued slow stirring. Phase F is added with stirring to make a conditioning cream rinse second composition.

For hair treatments the conditioning cream rinse first and second compositions are applied to the hair consecutively, with each application being followed by rinsing with water.

### EXAMPLE 9

### Conditioning Shampoo Formulation

A conditioning shampoo formulation for use according to this invention is made as described.

TABLE 9A

| Ingredient | Wt. % | Source of materials |
|---|---|---|
| Phase A | | |
| Deionized water | 59.8 | N/A |
| Ammonium lauryl sulfate | 15.0 | Rhodia Inc. |
| | | Home, Personal Care |
| | | and Industrial |
| | | Ingredients, |
| | | Cranbury NJ |
| Sodium lauryl sulfate | 15.0 | Rhodia Inc. |
| | | Home, Personal Care |
| | | and Industrial |
| | | Ingredients, |
| | | Cranbury NJ |
| Cocamidopropyl betaine | 8.0 | McIntyre Group Ltd, |
| | | University Park IL |
| Polyquaternium-7 | 1.0 | Nalco Company, |
| | | Naperville IL |
| Phase B | | |
| LAURAMIDE DEA | 2.0 | McIntyre Group Ltd, |
| | | University Park IL |
| Phase C | | |
| Diazolidinyl urea/IPBC | 0.2 | International |
| (GERMALL PLUS) | | Specialty Products, |
| | | Wayne, NJ |

Referring to Table 9A, the ingredients of Phase A are heated to 60° C. with slow stirring for approximately 30 minutes or until the solution becomes transparent. At the same time, the ingredients of Phase B are heated to 55° C. Phase B is then added to Phase A with continuous stirring. The heat source is removed, and the resulting solution is allowed to cool to 45° C. Once this solution reaches 45° C., Phase C is added. The resulting solution is allowed to cool to ambient temperature with continued slow stirring to produce conditioning shampoo first composition.

TABLE 9B

| Ingredient | Wt. % | Source of materials |
|---|---|---|
| Phase D | | |
| Deionized water | 59.8 | N/A |
| Ammonium lauryl sulfate | 15.0 | Rhodia Inc. |
| | | Home, Personal Care |
| | | and Industrial |
| | | Ingredients, |
| | | Cranbury NJ |
| Sodium lauryl sulfate | 15.0 | Rhodia Inc. |
| | | Home, Personal Care |
| | | and Industrial |
| | | Ingredients, |
| | | Cranbury NJ |
| Cocamidopropyl betaine | 8.0 | McIntyre Group Ltd, |
| | | University Park IL |
| Chicken albumin | 1.0 | Sigma Aldrich, St. |
| | | Louis, MO |
| Phase E | | |
| LAURAMIDE DEA | 2.0 | McIntyre Group Ltd, |
| | | University Park IL |
| Phase F | | |
| Diazolidinyl urea/IPBC | 0.2 | International |
| (GERMALL PLUS) | | Specialty Products, |
| | | Wayne, NJ |

Referring to Table 9B, the ingredients of Phase D are heated to 60° C. with slow stirring for approximately 30 minutes or until the solution becomes transparent. At the same time, the ingredients of Phase E are heated to 55° C. Phase E is then added to Phase D with continuous stirring. The heat source is removed, and the resulting solution is allowed to cool to 45° C. Once this solution reaches 45° C., Phase F is added. The resulting solution is allowed to cool to ambient temperature with continued slow stirring to produce conditioning shampoo second composition.

For hair treatments, the conditioning shampoo first and second compositions are applied consecutively, with each application being followed by rinsing with water.

### EXAMPLE 10

### Leave-In Hair Conditioner Formulation

A leave-in hair conditioner for use according to this invention is made as described.

TABLE 10A

| Ingredient | Wt. % | Source of materials |
|---|---|---|
| Phase A | | |
| Deionized water | 95.5 | N/A |
| POLYOX WSR N-80 | 0.25 | Amerchol Corporation |
| | | A subsidary of Dow |
| | | Chemical Company, |
| | | Piscataway NJ |
| Cetrimonium chloride | 0.5 | Stepan Company, |
| | | Northfield IL |
| Polyquaternium-10 | 0.25 | Amerchol Corporation |
| | | A subsidary of Dow |
| | | Chemical Company, |
| | | Piscataway NJ |
| Phase B | | |
| Cetearyl alcohol | 2.0 | Croda Inc., Edison, NJ |
| (CRODOCOL CS-50) | | |
| Ceteareth 20 | 0.5 | Croda Inc., Edison, NJ |
| Phase C | | |
| Phenoxyethanol | 0.5 | Sigma Aldrich, St. |
| | | Louis, MO |
| Propylene glycol | 0.5 | Sigma Aldrich, St. |
| | | Louis, MO |

Referring to Table 10A, Phase A ingredients are combined and heated to 60° C. with moderately slow stirring. The components of Phase B are melted and slowly added to Phase A with stirring until the mixture appears well mixed and homogeneous. The solution is allowed to cool to ambient temperature with continued slow stirring. Phase C is added with stirring to make a leave-in hair conditioner first composition.

TABLE 10B

| Ingredient | Wt. % | Source of materials |
|---|---|---|
| Phase D | | |
| Deionized water | 93.8 | N/A |
| Carbopol 940 | 0.2 | Noveon Consumer |
| | | Specialties Lubrizol |
| | | Advanced Materials, |
| | | Inc., Cleveland OH |
| Chicken albumin | 1.0 | Sigma Aldrich, St. |
| | | Louis, MO |
| Laureth phosphate | 0.5 | Rhodia Inc. |
| | | Home, Personal Care |
| | | and Industrial |
| | | Ingredients, |
| | | Cranbury NJ |
| Phase E | | |
| Cetearyl alcohol | 2.0 | Croda Inc., Edison, NJ |
| (Crodocol CS-50) | | |
| Ceteareth 20 | 0.5 | Croda Inc., Edison, NJ |
| Amodimethicone | 1.0 | Dow Corning |
| | | Corporation |
| | | Midland MI |
| Phase F | | |
| Phenoxyethanol | 0.5 | Sigma Aldrich, St. |
| | | Louis, MO |
| Propylene glycol | 0.5 | Sigma Aldrich, St. |
| | | Louis, MO |

Referring to Table 10B, Phase D ingredients are combined and heated to 60° C. with moderately slow stirring. The components of Phase E are melted and slowly added to Phase D with stirring until the mixture appears well mixed and homogeneous. The solution is allowed to cool to ambient temperature with continued slow stirring. Phase F is added with stirring to make a leave-in hair conditioner second composition.

For hair treatment, the first and second components of the leave-in hair conditioner are applied consecutively.

### EXAMPLE 11

### Conditioning Cream Rinse Containing Polyquaternium-10 and Post Spray

A conditioning cream rinse containing polyquaternium-10 and a post spray for use according to the present invention are described.

TABLE 11A

| Ingredient | Wt. % | Source of materials |
|---|---|---|
| Phase A | | |
| Deionized water | 93.7 | N/A |
| POLYSURF 67 CS | 0.5 | Hercules Incorporated |
| | | Aqualon Division, |
| | | Wilmington DE |
| Polyquaternium-10 | 0.5 | Amerchol Corporation |
| | | A subsidary of Dow |
| | | Chemical Company, |
| | | Piscataway NJ |
| Phase B | | |
| Cetearyl alcohol | 2.0 | Croda Inc., Edison, NJ |
| (CRODOCOL CS-50) | | |
| Glyceryl stearate | 1.5 | International |
| | | Specialty Products, |
| | | Wayne NJ |
| Ceteareth 20 | 0.8 | Croda Inc., Edison, NJ |
| Phase C | | |
| Phenoxyethanol | 0.5 | Sigma Aldrich, St. |
| | | Louis, MO |
| Propylene glycol | 0.5 | Sigma Aldrich, St. |
| | | Louis, MO |

Referring to Table 11A, Phase A ingredients are combined and heated to 60° C. with moderately slow stirring. The components of Phase B are melted and slowly added to Phase A with stirring until the mixture appears well mixed and homogeneous. The solution is allowed to cool to ambient temperature with continued slow stirring. Phase C is added with stirring to make a conditioning cream rinse first composition containing polyquaternium-10.

TABLE 11B

| Ingredient | Wt. % | Source of materials |
|---|---|---|
| Phase D | | |
| Deionized water | 93.5 | N/A |
| POLYOX WSR N-80 | 0.5 | Amerchol Corporation |
| | | A subsidary of Dow |
| | | Chemical Company, |
| | | Piscataway NJ |
| Albumin (100%) | 1.0 | Sigma Aldrich, St. |
| | | Louis, MO |
| Phase E | | |
| Cetearyl alcohol | 2.0 | Croda Inc., Edison, NJ |
| (CRODOCOL CS-50) | | |
| Glyceryl stearate | 1.5 | International |
| | | Specialty Products, |
| | | Wayne NJ |
| Ceteareth 20 | 0.5 | Croda Inc., Edison, NJ |
| Phase F | | |
| Phenoxyethanol | 0.5 | Sigma Aldrich, St. |
| | | Louis, MO |
| Propylene glycol | 0.5 | Sigma Aldrich, St. |
| | | Louis, MO |

Referring to Table 11B, Phase D ingredients are combined and heated to 60° C. with moderately slow stirring. The components of Phase E are melted and slowly added to Phase D with stirring until the mixture appears well mixed and homogeneous. The solution is allowed to cool to ambient temperature with continued slow stirring. Phase F is added with stirring to make a conditioning cream rinse post spray second composition.

The first composition of the conditioning cream rinse with polyquaternium-10 and the second composition of the conditioning cream rinse post spray are applied to the hair consecutively. The application of the first composition is followed by a water rinse.

### EXAMPLE 12

### Anti-Fade Post-Dye Hair Conditioner and Post Spray

An anti-fade post-dye hair conditioner and post spray for use according to this invention are described.

TABLE 12A

| Ingredient | Wt. % | Source of materials |
|---|---|---|
| Phase A | | |
| Deionized water | 93.0 | N/A |
| CRODASOFT DBQ | 2.0 | Croda Inc., Edison, NJ |
| Polyquaternium-10 | 0.5 | Amerchol Corporation |
| | | A subsidary of Dow |
| | | Chemical Company, |
| | | Piscataway NJ |
| Cetearyl alcohol | 4.0 | Croda Inc., Edison, NJ |
| (CRODOCOL CS-50) | | |
| Phase B | | |
| Phenoxyethanol | 0.5 | Sigma Aldrich, St. |
| | | Louis, MO |

Referring to Table 12A, the ingredients in Phase A are combined and heated to 80-85° C. with mixing. The mixture is then held at 80-85° C. for 10 minutes with continued stirring. The mixture is then cooled to 55° C., and the ingredient in Phase B is added. The mixture is then cooled to ambient temperature and the pH adjusted to 5.5 if necessary to make anti-fade post-dye hair conditioner first composition.

TABLE 12B

| Ingredient | Wt. % | Source of materials |
|---|---|---|
| Phase C | | |
| Deionized water | 93.0 | N/A |
| POLYOX WSR N-80 | 0.5 | Amerchol Corporation |
| | | A subsidary of Dow |
| | | Chemical Company, |
| | | Piscataway NJ |
| Albumin (100%) | 1.0 | Sigma Aldrich, St. |
| | | Louis, MO |
| Laureth phosphate | 0.5 | Rhodia Inc. |
| | | Home, Personal Care |
| | | and Industrial |
| | | Ingredients, |
| | | Cranbury NJ |
| Phase D | | |
| Cetearyl alcohol | 2.0 | Croda Inc., Edison, NJ |
| (CRODOCOL CS-50) | | |
| Glyceryl stearate | 1.5 | International |
| | | Specialty Products, |
| | | Wayne NJ |
| Ceteareth 20 | 0.5 | Croda Inc., Edison, NJ |
| Phase E | | |
| Phenoxyethanol | 0.5 | Sigma Aldrich, St. |
| | | Louis, MO |
| Propylene glycol | 0.5 | Sigma Aldrich, St. |
| | | Louis, MO |

Referring to Table 12B, Phase C ingredients are combined and heated to 60° C. with moderately slow stirring. The components of Phase D are melted and slowly added to Phase C with stirring until the mixture appears well mixed and homogeneous. The solution is allowed to cool to ambient temperature with continued slow stirring. Phase E is added with stirring to make an anti-fade post-dye conditioner post spray second composition.

The first composition of the anti-fade post-dye hair conditioner and the second composition of the anti-fade post-dye conditioner post spray are applied to the hair consecutively. The application of the first composition is followed by a water rinse.

The specification and embodiments above are presented to aid in the complete and non-limiting understanding of the invention disclosed herein. Since many variations and embodiments of the invention can be made without departing from its spirit and scope, the invention resides in the claims hereinafter appended.

What is claimed is:

1. A method for providing a benefit to a keratin-containing substrate comprising sequentially:
d) providing a first cosmetic composition comprising at least one cationic compound selected from the group consisting of cationic proteins, cationic peptides, cationic polymers, and the mixtures thereof;
e) applying said first cosmetic composition to the keratin-containing substrate for a time period sufficient for at least one said cationic compound to be deposited on the substrate and form a first layer;
f) providing a second cosmetic composition comprising at least one anionic compound selected from the group consisting of anionic proteins, anionic peptides, anionic polymers, anionic surfactants, and the mixtures thereof; and
applying said second cosmetic composition to the keratin-containing substrate for a time period sufficient for at least one anionic compound to be deposited on said first layer to form a second layer.

2. A method according to claim 1, wherein said cationic compound is a cationic protein.

3. A cosmetic composition according to claim 1, wherein said naturally-occurring cationic protein is selected from the group consisting of lysozyme, avidin, antimicrobial proteins, RNA or DNA binding proteins, proteases, methylated collagen, Cytochrome C, proteins involved in the aging process, Platelet Factor 4, protamine sulfate and mixtures thereof.

4. A method according to claim 3 wherein said antimicrobial proteins are selected from the group consisting of: magainin, defensins, cathelicdin and mixtures thereof.

5. A method according to claim 3 wherein said RNA or DNA binding proteins are selected from the group consisting of histones, ribonuclease A, Deoxyribonuclease and mixtures thereof.

6. A method according to claim 3 wherein said proteases are selected from the group consisting of Trypsin, Chymotrypsin, Papain, Caspase and mixtures thereof.

7. A method according to claim 1, wherein said cationic compound is a cationic peptide.

8. A method according to claim 7 wherein said cationic peptide is selected from the group consisting of polylysine, polyarginine, polyhistidine, polyasparagine, polyglutamine, copolymers and peptides containing a greater number of basic amino acids than acidic amino acids, and the mixtures thereof.

9. A method according to claim 1, wherein said cationic compound is a cationic polymer.

10. A method according to claim 9, wherein said cationic polymer is a naturally-occurring polymer that is cationically modified selected from the group consisting of chitosan, cationic cellulose, cationic starch, cationic guar gum, and mixtures thereof.

11. A method according to claim 9, wherein said cationic polymer is a synthetic cationic polymer selected from the group consisting of synthetic cationic polymers comprising one or more primary amines, synthetic cationic polymers comprising one or more secondary amines, synthetic cationic polymers comprising one or more tertiary amines, synthetic cationic polymers comprising one or more quaternary amines, and the mixtures thereof.

12. A method of according to claim 11, wherein said synthetic cationic polymer is selected from the group consisting of poly methacrylamidopropyltrimethylammonium chloride, polyquaternium-1, polyquaternium-2, polyquaternium-5, polyquaternium-6, polyquaternium-7, polyquaternium-8, polyquaternium-11, polyquaternium-16, polyquaternium-17, polyquaternium-18, polyquaternium-22, polyquaternium-27, polyquaternium-28, polyquaternium 31, polyquaternium-39, polyquaternium-43, polyquaternium-44, polyquaternium-46, polyquaternium-47, polyquaternium-53, polyquaternium-55, PVP/dimethylaminoethyl methacrylate copolymer, VP/dimethylaminoethyl methacrylate copolymer, VP/DMAPA acrylate copolymer, VP/vinyl caprolactam/DMAPA acrylates copolymer, vinylcaprolactam/PVP/dimethylaminoethylmethacrylate copolymer, and the mixtures thereof.

13. A method according to claim 1, wherein said anionic compound is an anionic protein.

14. A method according to claim 13 wherein said anionic protein is a naturally occurring anionic protein selected from the group consisting of wheat acidic esterase, alkaline phosphatase, beta-galactosidase, lactase, lipase, amylases, epidermal growth factor, glycosidases, glucose oxidase, nitrate reductase, catalase, lactoglobulin, carboanhydrase, casein proteins in milk, trypsin inhibitor, proteins found in egg white including ovalbumin, gamma-globulin, and ovomucin, cathepsin, albumin, and mixtures thereof.

15. A method according to claim 1, wherein said anionic compound is an anionic peptide.

16. A method according to claim 15, wherein said anionic peptide is selected from the group consisting of polyglutamic acid, polyaspartic acid, and peptides containing a greater total number of acidic amino acids than basic amino acids, and mixtures thereof.

17. A method according to claim 1, wherein said anionic compound is an anionic polymer.

18. A method according to claim 17, wherein said anionic polymer is a naturally-occurring anionic polymer selected from the group consisting of alginic acid, propylene glycol alginate, carageenan gum, cellulose gum, gum Acacia, karaya gum, xanthan gum, tragacanth gum, hyaluronic acids, shellac, anionically modified cellulose, guar gum, and starch, and the mixtures thereof.

19. A method according to claim 18, wherein said anionic polymer is a synthetic anionic polymer selected from the group consisting of, sodium polystyrene sulfonate, sodium polymethacrylate, sodium polyacrylate, sodium polynaphtalenesulphonate, acrylates/C10-30 alkyl acrylate crosspolymer, acrylates/beheneth-25 methacrylate copolymer, acrylates/steareth-20 methacrylate copolymer, acrylates/VA crosspolymer, vinyl isodecanoate crosspolymer, acrylic acid/acrylonitrogens copolymer, carbomerPVM/MA decadiene crosspolymer, acrylates copolymer, octylacrylamide/acrylates/butylaminoethylmethacrylate copolymer, PVM/MA copolymer, VA/crotonates/vinyl neodecanoate copolymer, glyceryl polymethacrylate, and the mixtures thereof.

20. A method according to claim 1, wherein said anionic compound is an anionic surfactant.

21. A method according to claim 20, wherein said anionic surfactant are alkyl sulphates, alkyl ether sulphates, alkaryl sulphonates, alkanoyl isethionates, alkyl succinates, alkyl sulphosuccinates, N-alkyl sarcosinates, alkyl phosphates, alkyl ether phosphates, alkyl ether carboxylates, and alpha-olefin sulphonates, especially their sodium, magnesium, ammonium, and mono-, di-, and triethanolamine salts. The alkyl and acyl groups generally contain from 8 to 18 carbon atoms and may be unsaturated. The alkyl ether sulfates, alkyl ether phosphates, and alkyl ether carboxylates may contain from 1 to 10 ethylene oxide or propylene oxide units per molecule.

22. A method according to claim 1, wherein said keratin-containing substrate is selected from the group consisting of hair, skin, nails, teeth, tissues, wool and fur.

23. A method according to claim 1, wherein said method imparts a conditioning benefit to said substrate selected from the group consisting of improved combability, shine, softness, moisturizing, detangling, and the combination thereof.

24. A method according to claim 1, wherein said cationic compound has an Isoelectric Point of at least 6.

25. A method according to claim 24, wherein said cationic compound has an Isoelectric Point of from about 8 to about 12.

26. A method according to claim 1, wherein said anionic compound has an Isoelectric Point of about 7 to about 2.

27. A method according to claim 1, wherein said cationic compound has a concentration range from about 0.000001% to about 10% by weight.

28. A method according to claim 27, wherein said cationic compound has a concentration range from about 0.001% to about 5% by weight.

29. A method according to claim 28, wherein said cationic compound has a concentration range from about 0.01% to about 2% by weight.

30. A method according to claim 1, wherein said anionic compound has a concentration range from about 0.000001% to about 10% by weight.

31. A method according to claim 30, wherein said anionic compound has a concentration range from about 0.001% to about 5% by weight.

32. A method according to claim 31, wherein said anionic compound has a concentration range from about 0.01% to about 2% by weight.

33. A cosmetic kit for providing a benefit to a keratin-containing substrate comprising:
a) a first container containing a first cosmetic composition comprising at least one cationic compound selected from the group consisting of cationic proteins, cationic peptides, cationic polymers, and the mixtures thereof;
wherein said first composition is applied to the keratin-containing substrate for a time period sufficient for at least one said cationic compound to be deposited on the substrate and form a first layer, and then rinsed off with water;
b) a second container containing a second cosmetic composition comprising at least one anionic compound selected from the group consisting of anionic proteins, anionic peptides, anionic polymers, and the mixtures thereof;
wherein said second cosmetic composition is applied to the keratin-containing substrate for a time period sufficient for at least one anionic compound to be deposited on said first layer to form a second layer, and then raised off with water.

34. A conditioned keratin-containing substrate prepared by the method of claim 1.

35. A bi-layered coating on a keratin-containing substrate prepared by the method of claim 1 comprising a cationic layer and an anionic layer.

36. A method according to claim 1 further comprising the step of rinsing said second cosmetic composition with water.
